(19) United States
(12) Patent Application Publication
(10) Pub. No.: US 2004/0206411 A1
(43) Pub. Date: Oct. 21, 2004

(54) Water supply pipe liner

(76) Inventor: Raymond Connor, Derbyshire (GB)

Correspondence Address: QUARLES & BRADY STREICH LANG, LLP, ONE SOUTH CHURCH AVENUE, SUITE 1700, TUCSON, AZ, 85701-1621, US

(21) Appl. No.: 10/479,063

(22) PCT Filed: May 29, 2002
(86) PCT No.: PCT/GB02/02252

(30) Foreign Application Priority Data
May 29, 2001 (GB) 0112908.9

(51) Int. Cl. F16L 55/16

(52) U.S. Cl. 138/98

(57) ABSTRACT

A liner for a water supply or other pipe comprises an extrusion of an elastomeric material (10), which is extruded in a semi-collapsed multi-lobed state, and encased in a heat shrinkable film (11). The film (11) is formed with lines of perforations (13) there along, and after shrinking the liner and film combination may be introduced into a pipe (12) and then expanded by applying water pressure within the liner, causing the liner to expand and tear the film along the lines of perforation (13), and expand the liner until it contacts the inner wall of the pipe

This invention relates to method and apparatus for rehabilitation of water supply and other pipes.

A method of rehabilitating a water supply pipe has been proposed comprising deploying a tubular liner within the pipe, the liner comprising an elastomeric polyolefin. The lining step is carried out by drawing the liner into the pipe by a line attached to a foam pig sent through the pipe by fluid pressure. The liner is fed in a semi-collapsed form, presenting for example four or six lobes in cross-section to resemble a cross or star shape, and has an inner support in the form of a core rod which is of matching cross-section. After insertion of the liner into the pipe, the core rod is withdrawn, and the liner is inflated by the pressure of water within the liner, to abut the inner walls of the pipe.

The above method is principally directed to the rehabilitation of small-bore lead pipes, with internal diameters typically below 25 mm, used in household water supply. However, a major problem exists also with large diameter steel or other metal pipes used as water mains. Such pipes are vulnerable to stresses caused by earth movement, manifesting most notably in earthquakes. As a result of major earthquakes in Japan and California, iron and steel pipe lines used for gas and water supplies were shown to be fragile. Secondary fires from failed gas main pipes contributed to the damage, and damaged water supplies caused local floods, and disrupted fire fighting.

Similar, if less extreme, stresses arise in earth movements due to other causes, such as mining subsidence, or land-slips due to erosion damage.

It is therefore an object of the invention to provide a means for providing earth movement failure protection to large bore metal pipes, as a less expensive alternative to total replacement with plastic pipes.

In accordance with the present invention, a liner comprises an elastomeric extrusion, the extrusion having been formed in a semi-collapsed state and having a multi-lobed cross-sectional shape, characterised in that an external sleeve of heat shrinkable film material, provided with one or more lines of perforations running along Its length is applied to the liner.

The liner may be radially compressed by the sleeve of heat shrinkable film and may be suitable for use in the method described above, and is adoptable to any diameter of host pipe.

The invention also provides a method of providing a lining on a utility pipe comprising forming a liner as a semi-collapsed extrusion of an elastomeric material having a multi-lobed cross-section shape, characterised in that an external sleeve of heat shrinkable film material, provided with one or more lines of perforations running along its length, is applied to the liner and the externally applied sleeve shrunk about the liner. This may be applied in a continuous post production process to the outer surface of the liner, for example as a continuous concentric extrusion about the extruded liner, followed immediately by heat shrinking of the externally applied sleeve. The sleeve may be of a material such as PVC or PET.

The sleeve may be manufactured with one or more lines of perforations running along its full length. This will allow the sleeve to rupture when the liner is inflated by pipeline water pressure applied with the liner after installation as the liner reaches its intended diameter. The sleeve may then be discarded as a sacrificial skin.

The circumference of the semi-collapsed liner may be calculated to fit accurately within the host pipe however large when fully expanded after installation, by pipeline water pressure.

The host pipe may be of any dimension, from domestic pipes, to large diameter mains pipes.

With large diameter metal mains pipes, connections can be made by welding the liner to existing plastic components which permits fusion jointing to a standard range of pipes and fittings. The pre-expanded liner may be pulled through the host pipe by a winch, and then inflated by application of water pressure internally of the lining.

A sealing gel, mastic foam, or grout may be applied between the liner and the host pipe wall. Such a coating may be primarily carried in the flutings or pleats of the pre-expanded multi-lobed liner extrusion. Sealing materials of this type can prevent tracking of fluid at the interface by diffusion through the liner when high pressure fluids are carried by the pipeline.

The extrusion may be adapted for other uses for example as a drip or infusion or -ostomy bag for use in medicine.

A preferred embodiment of the extrusion, and modified liner of the invention will now be described by way of example, with reference to the accompanying drawings, wherein:

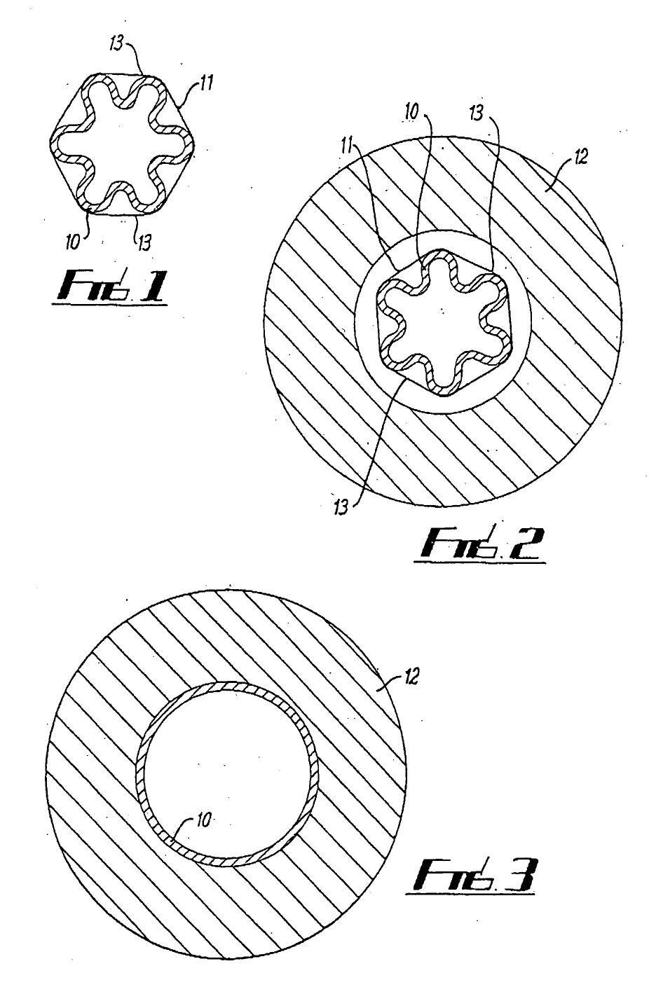

FIG. 1 is a cross-sectional view of an extrusion according to the invention in the form of a liner for use in the method and apparatus of the invention, with a shrink-sleeve applied externally, prior to heat-shrinking of the sleeve;

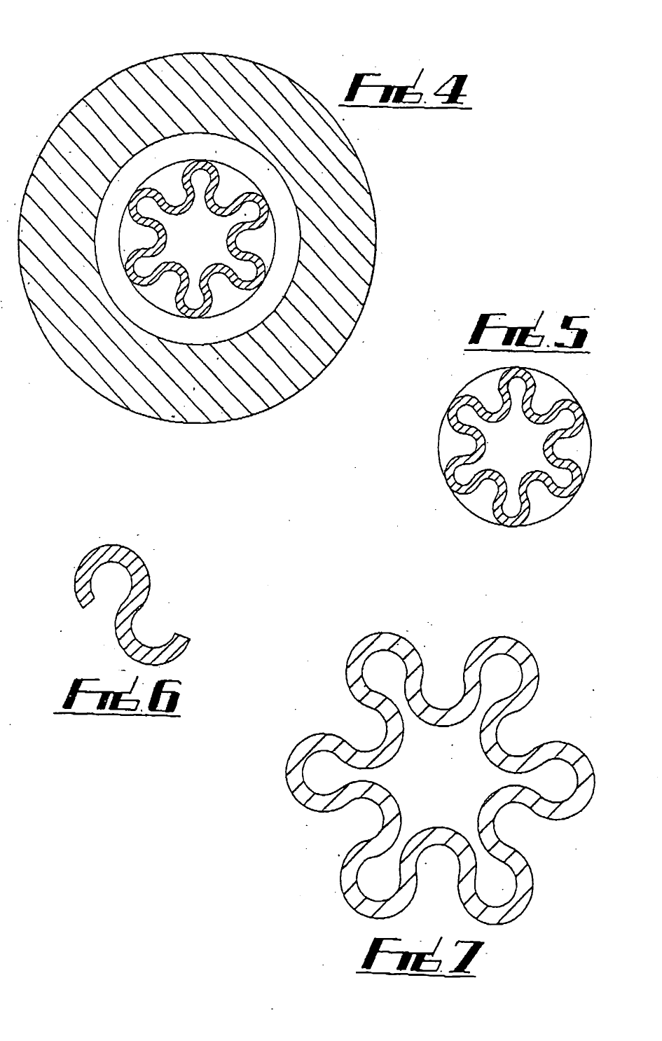

FIG. 2 is a cross-sectional view of the liner with the shrunk sleeve inserted into a water supply pipe, prior to expansion of the liner by internal fluid pressure; and

FIG. 3 is a cross-sectional view of the liner within the water supply pipe, following expansion of the liner.

In FIG. 1, a liner 10 for use in lining a water supply pipe is formed from an elastomeric ethylene copolymer, sold by DuPont Dow SA under the Trade Mark ENGAGE. This is configured as a fluted or ribbed tube having six lobes with re-entrant pleats to form a star-shaped cross-section. As the liner is produced, it is sheathed in a heat-shrinkable sleeve 11 of PET or PVC. This is shown in its unshrunk state in FIG. 1. After sheathing of the liner 10 in the sleeve 11, the assembly is subjected to heating in a suitable oven or heated bath which causes the sleeve 11 to shrink, also causing the elastomeric liner 10 to compress and thus reduce its overall dimensions whilst retaining its generally tubular fluted cross-section.

The sheathed lining may be stored and transported to the site of use in this compressed state with the shrunken sleeve tightly holding it against its resilient urge to expand.

At the site of use, the liner is inserted into a water pipe 12 using a technique such as described in the above mentioned patent application. No core rod is shown in FIG. 2 within the liner, and the liner 10 may be inserted without a core. Alternatively a core may be employed. In large diameter main pipes, the liner is pulled through the host pipe by a winch.

FIG. 2 shows the liner 10 within pipe 12, which may be a household lead water pipe, or branch pipe accessing domestic premises from a water company mains. The liner 10 is compressed within shrunk sleeve 11. The sleeve 11 has one or two lines of weakness 13 formed by lines of perforations, extending all the way along the length of the sleeve 11.

After installation of the liner 10, it is connected up so that water supply pressure is supplied within the liner 10. The liner 10 expands under the pressure of the water when the supply is turned on, and the sleeve 11 splits along the lines of weakness 13, to allow the liner 10 to expand fully, and be pressed against the inner wall of pipe 12 by the water pressure. The split sleeve 11 is discarded as a sacrificial skin.

The drawings are at approximately four times actual dimensions.

The reduced dimensions of the liner 10 within the sleeve enables the liner to be easily inserted into a pipe. The liner may be extruded as small as 9.5 mm diameter as e.g. a six-lobed fluted tube, so as to expand or contract under water pressure whilst retaining its geometric integrity to accommodate bends and resist twisting during production and installation and resist any collapse possible under a vacuum in the pipe.

The liner 10 can be installed as a self-supporting system with or without use of a core rod, or may be subjected to a vacuum or partial vacuum applied internally if it is required to further reduce the radial dimensions uniformly down to say 6 or 8 mm without the need for a supporting core rod.

The described sleeving with heat-shrinkable film may also reduce the diameter of the liner to 6 to 8 mm diameter and also protects the liner against abrasion during insertion. This is of considerable importance particularly when drawing the liner into the pipe by which particularly where the interior of the pipe is roughened by corrosion or deposits.

The above dimensions apply to a liner for a domestic supply pipe. However the invention can also be used to protect large diameter mains pipes of e.g. steel or iron against leakage following failure resulting from earth movements, from major earthquakes to local slippage or subsidence.

The main advantage of the lining is however its likely response to severe deformation and shearing of the host pipe consequent upon land-slip or earthquake. The nature of such ground movement is to create external forces on a pipe that even with very strong materials, the forces exceed the failure limit of metallic systems.

The tough, elastomeric internal liner will however stretch and move with the ground and despite the high strains will distort without failure. Thus the internal fluid will remain contained, and even if flow is reduced the danger of external losses is greatly reduced.

The polyolefin elastomeric profile is produced by known extrusion methods described above.

As with small bore pipes the circumference of the semi collapsed liner is calculated to fit accurately inside the host pipe when fully expanded under fluid pressure.

In large diameter pipe liners the profile can be extruded and die drawn to a reduced dimension as a six lobed convoluted design, to fit the host pipe; to expand or contract under hydrostatic pressure, whilst retaining its geometric integrity. The profile is designed to accommodate bends and resist twisting during installation and any likely collapse of vacuum in the host pipe.

The star sectioned liner can be transported in long coiled lengths and installed over large distances as a self supporting flexible system with or without a winch, and large diameter lines can be subjected to a vacuum or partial vacuum if required to further reduce radial dimensions uniformly down to fit the hosts pipe dimensions without the need for expensive on site forming machines. The liner can also be further protected in transit through the host pipe by using a sacrificial, heat shrinkable, PET or PVC film sleeve, as disclosed above to further reduce the radial dimensions in conjunction with a vacuum reduction and can be designed to take inserts and standard compressions fittings liner can also incorporate a sealing gel, mastic, foam or grout between the liner and the hot pipe wall. There is no limitation on the size of pipe to which the liner can be applied. The liner will seal leaks from a perforated host pipe or poor joints and can travel around bends and overcome offsets at pipe joints.

The liner may be installed to be set thermally in place of use within the host pipe by use of hot water to form a permanent close fitting liner.

The liner can also be designed to be compatible with inserts and standard compression fittings.

Further embodiments of elastomeric extrusion according to the invention may be adapted for other uses, notably in medicine for use as drip or infusion bags, or -ostomy bags for collecting discharged body fluids.

The extrusion may also be adapted for use in the automotive and other industries, and may be provided with any desired combination of lobes and re-entrant pleats.

Possible further pleat configurations are shown in Figure to 7 also enclosed.

1. A liner comprising an elastomeric extrusion the extrusion having been formed in a semi-collapsed state and having a multi-lobed cross-sectional shape, characterised in that an external sleeve (11) of heat shrinkable film material, provided with one or more lines of perforations (13) running along its length is applied to the liner (10).

2. A method of providing a lining in a utility pipe comprising forming a liner (10) as a semi-collapsed extrusion of an elastomeric material having a multi-lobed cross-sectional shape, charecterised in that an external sleeve (11) of heat shrinkable film material provide with one or more lines of perforations (13) running along its length, is applied to the liner (10) and the externally applied sleeve (11) shrunk about the liner (10).

3. A method according to claim 2 wherein the external sleeve (11) is applied continuously as a concentric extrusion surrounding the extruded liner (10), and the sleeve (11) is immediately thereafter heat-shrunk onto the liner to radially inwardly compress the liner.

4. A method according to either of claims 2 or 3 comprising the further steps of pulling the liner (10) through a host pipe using a winch and inflating the liner by application of water pressure internally of the lining.

5. A method according to claim 4, wherein a seating gel, mastic, foam or grout is applied between the liner (10) and the host pipe wall by application to the pre-expanded liner and being carried in the flutings, or pleats of the pre-expanded liner.
